(19) United States
(12) Patent Application Publication
(10) Pub. No.: US 2004/0174534 A1
(43) Pub. Date: Sep. 9, 2004

(54) Interferometer, exposure apparatus and method for manufacturing device

(76) Inventor: Eiji Aoki, Tochigi (JP)

Correspondence Address: MORGAN & FINNEGAN, L.L.P., 345 PARK AVENUE, NEW YORK, NY, 10154, US

(21) Appl. No.: 10/793,510

(22) Filed: Mar. 3, 2004

(30) Foreign Application Priority Data
Mar. 7, 2003 (JP) 2003-061267

(51) Int. Cl. G01B 9/02

(52) U.S. Cl. 356/515

(57) ABSTRACT

A method for measuring aberration of an optical system that constitutes an interferometer comprises a step of disposing a reflecting member at an image point of the optical system and a step of detecting, by detection means, interference fringes formed based on light that has been emitted from a light source, transmitted through the optical system, caused to illuminate the reflecting member, reflected by the reflecting member and transmitted through the optical system again. The refractive index of the reflecting member with respect to the light is equal to or larger than 1.8.

### BACKGROUND OF THE INVENTION

1. Field of the Invention

The present invention generally relates to an interferometer, and particularly to an interferometer for measuring a wavefront. The present invention is preferably applied to measurement of a transmitted wavefront transmitted of a projection lens in a projection optical system. Particularly, the present invention is preferably applied, among other interferometers used for wavefront measurement, to an apparatus for measuring a system error of a Fizeau interferometer. The present invention also relates to an exposure apparatus having a lens that has been measured by such an interferometer.

2. Related Background Art

When devices are produced utilizing photolithography technology, a projection optical apparatus for projecting a circuit pattern formed on a mask onto a wafer by means of a projection optical system to transfer the circuit pattern has been conventionally used. In order to meet recent demands for size and thickness reduction of electronic instruments, it is necessary to increase the integration density of devices used in the electronic instruments. Consequently, demands for miniaturization of circuit patters to be transferred or an increase in resolution are increasing. In order to attain high resolutions, it is effective to reduce the wavelength of the light source or to increase the numerical aperture (NA) of the projection optical system. However, it is also necessary to make aberrations of the projection optical system extremely low.

In order to measure aberrations of a projection optical system, it is necessary to measure a wavefront transmitted through the projection optical system with high accuracy. An interferometer has been conventionally used as an apparatus for such measurement. Among others, a Fizeau interferometer in which the reference arm and the test arm are on a common path has been used as an interferometer capable of measuring a wavefront transmitted through an optical system to be measured with high accuracy, since it is hardly influenced by variations in refractive index distribution of the gas in the optical path of the interferometer.

When a wavefront is measured by an interferometer, the phase of a wavefront transmitted through an optical system to be measured (i.e. a test arm wavefront) is calculated using a reference wavefront (i.e. a reference arm wavefront) reflected from a reference surface as a reference. Therefore, measurement accuracy cannot exceed the surface accuracy of the reference surface. Even in the case of highly precise interferometers available in the market, the surface accuracy of the reference surface is about λ/10 to λ/20 (λ=632.8 nm) at the best, and therefore it is not possible to attain measurement accuracy higher that that by one wavefront measurement. In view of the above, a method in which an error inherent to the optical system of an interferometer (which will be referred to as a system error hereinafter) such as a surface error of the reference surface is measured by some means and the system error is subtracted from measured wavefront data to extract only the component of the test arm wavefront has been adopted.

A method for measuring such a system error is described in detail in “Optical Shop Testing” 2nd edition, Daniel Malacara, 1992, pp577-580, Wiley Canada Publishers. In the following the outline of that method will be described with reference to FIGS. 3A to 3C. In FIGS. 3A to 3C, reference numeral 31 designates a Fizeau lens of a Fizeau interferometer. The right side surface 31a of the Fizeau lens in FIG. 3A is a Fizeau surface, and the wavefront reflected by that surface constitutes a reference arm wavefront in the transmitted wavefront measurement of an optical system to be measured. In order to determine a system error, three types of measurement as shown in FIGS. 3A to 3C are carried out.

In the measurement process shown in FIG. 3A, an concave mirror 32 that is disposed in such a way that its center of curvature coincides with a focal point of the Fizeau lens is used. A light flux traveling from the left side of FIG. 3A is converged at the focal point by the Fizeau lens 31 and then reflected by the concave mirror 32. Since the focal point of the Fizeau lens 31 and the center of curvature of the concave mirror 32 coincide with each other, the light flux reflected by the concave mirror 32 travels back the same optical path as the light approaching the concave mirror 32 so as to be incident on the Fizeau lens 31 again. In this process, three factors will affect the wavefront, that is, the Fizeau surface 31, the concave mirror 32 and the optical elements (not shown) arranged on the left side (under the orientation shown in FIG. 3A) of the Fizeau lens 31 in the interferometer. Here, let W_{T} represent a wavefront error caused by the Fizeau surface 31a, W_{S} represent a wavefront error caused by the concave mirror 32, and W_{R} represent a wavefront error caused by the optical elements arranged on the let side (under the orientation shown in FIG. 3A) of the Fizeau lens 31 in the interferometer. In the measurement of a wavefront transmitted through an optical system to be measured, the wavefront error W_{S} caused by the concave mirror 32 does not have an influence on the measurement of the transmitted wavefront, since the concave mirror is replaced by the optical system to be measured. In contrast, the other wavefront errors W_{T} and W_{R} affect the measurement result of the measurement of the transmitted wavefront of the optical system to be measured as system errors. Therefore, it is necessary to measure the wavefront errors W_{T} and W_{R} with high accuracy.

Letting W₁ be the wavefront error under the state shown in FIG. 3A, W₁ includes all of the aforementioned wavefront errors and W₁ is expressed by the following formula.

W₁=W_{R}+W_{T}+W_{S} (1)

Under the state shown in FIG. 3B, the concave mirror 32 has been rotated about the optical axis by 180° from the state shown in FIG. 3A. In this case, the wavefront error W2 is represented by the following formula.

W₂=W_{R}+W_{T}+W^{180°}_{S} (2)

In this formula, W ^{180°}_{S} represents the wavefront error under the state in which the concave mirror 32 has been rotated by 180° and W_{T} and W_{R} are the same as those in FIG. 3A.

Next, in the process shown in FIG. 3C, a flat plate is placed at the focal position of the Fizeau lens 31 instead of the concave mirror 32, and cat's-eye measurement is carried out while achieving a cat's eye reflection. In this case, the wavefront error W₃ is expressed by the following formula.

W₃=W_{R}+1/2(W_{T}+W^{180°}_{T}) (3)

From formulas (1) to (3), we obtain the following formulas (4) and (5).

W_{S}=1/2(W₁+W^{180°}₂−W₃−W^{180°}₃) (4)

W_{I}=1/2(W₁−W^{180°}₂+W₃+W^{180°}₃) (5)

In the above formulas, W_{S} is the wavefront error component caused by a surface error of the concave mirror 32 as mentioned above and W₁ is the wavefront error component of the interferometer including the Fizeau surface, which is equal to the sum of W_{T} and W_{R}. Thus, the system error W₁ of the interferometer can be determined.

In the foregoing, the outline of a method for measuring a system error of an interferometer has been described, and as to the detail of the method reference is made to “Optical Shop Testing” 2nd edition, pp577-580 cited before. Here, what is important is that a system error of an interferometer is measured by the measurement process as shown in FIGS. 3A to 3C.

On the other hand, when a wavefront is measured by an interferometer, it is sometimes necessary to measure as an evaluation amount a wavefront error with respect to linearly polarized light or a wavefront with respect to non-polarized light depending on the object to be measured. In that case, a linearly polarized light source is used as the light source of the interferometer thereby making a light flux of linearly polarized light to enter the object to be measured. In the case that a wavefront error with respect to non-polarized light is to be measured, wavefront errors with respect to linearly polarized lights with polarization directions orthogonal to each other are measured and those errors are averaged.

In recent years, the numerical aperture (NA) of the projection optical system of semiconductor exposure apparatuses tends to be as large as or larger than 0.8. Consequently, it is necessary for the Fizeau lens of the interferometer, which makes a light flux with a desired NA incident on a test lens subjected to transmitted wavefront measurement, to have an NA higher than that. However, it is often the case that the light source used for measuring transmitted wavefront of high NA lenses is linearly polarized light, and when cat's-eye measurement of a high NA Fizeau lens is performed, the reflectance for P-polarized light, in which the polarization direction of the light source and the reflection surface is coplanar as shown in FIG. 4A, decreases as the incidence angle on a substrate (made of, for example, fused silica) or the NA (sinθ) increases. Thus, the reflectance becomes zero at the angle at which the reflection angle becomes equal to the Brewster's angle (tan⁻¹(n2/n1), where n2 is the refractive index of the substrate and n1 is the refractive index of the incidence side). Consequently, in the case of the cat's-eye measurement, no reflection light from that area (the area indicated by the circles indicated by broken lines in FIG. 4A) of the substrate surface returns to the interferometer, and therefore the contrast of the interference fringes becomes low or the interference fringes even disappear. In this way, the accuracy of wavefront measurement of the cat's-eye reflection is considerably deteriorated and it is difficult to measure the system error of an interferometer having a high NA.

### SUMMARY OF THE INVENTION

In view of the above, an exemplary object of the present invention is to provide a measurement apparatus with which cat's-eye measurement of a Fizeau lens having a high NA can be carried out with high accuracy, and to provide also a Fizeau interferometer, an exposure apparatus and a method for manufacturing devices.

In order to attain the above object, according to one aspect of the present invention, there is provided a method for measuring aberration of an optical system that constitutes an interferometer, comprising a step of disposing a reflecting member at an image point of the optical system and a step of detecting, by detection means, interference fringes formed based on light that has been emitted from a light source, transmitted through the optical system, caused to illuminate the reflecting member, reflected by the reflecting member and transmitted through the optical system again, wherein the refractive index of the reflecting member with respect to the light is equal to or larger than 1.8.

Other objects and features of the present invention will become apparent from consideration of the following description of the preferred embodiments that will be made with reference to the accompanying drawings.

### BRIEF DESCRIPTION OF THE DRAWINGS

FIG. 1 is a diagram showing the optical path of an Fizeau interferometer for measuring a transmitted wavefront according to a first embodiment of the present invention.

FIG. 2 is a diagram showing the optical path of an Fizeau interferometer for measuring a surface shape according to a second embodiment of the present invention.

FIGS. 3A, 3B and 3C are optical path diagrams showing a conventional system error measurement process of an interferometer.

FIGS. 4A and 4B are a cross sectional view for showing the direction of polarization on a pupil plane of the Fizeau lens and a side view respectively presented for illustrating a problem of the interferometer shown in FIGS. 3A, 3B and 3C.

FIG. 5 is a graph showing a relationship between NA and intensity reflectance for P polarized light in the case that the refractive index of a reflecting substrate used for cat's-eye measurement is 1.508.

FIG. 6 is a graph showing a relationship between NA and intensity reflectance for P polarized light in the case that the refractive index of a reflecting substrate used for cat's-eye measurement is 1.847.

FIG. 7 is a graph showing a relationship between NA and intensity reflectance for P polarized light in the case that the refractive index of a reflecting substrate used for cat's-eye measurement is 1.90.

FIG. 8 is a block diagram schematically showing an exposure apparatus according to the present invention.

FIG. 9 is a flow chart for illustrating a device manufacturing process using the exposure apparatus according to the present invention.

FIG. 10 is a detailed flow chart of step 4 show in the flow chart of FIG. 9.

### DESCRIPTION OF THE PREFERRED EMBODIMENTS

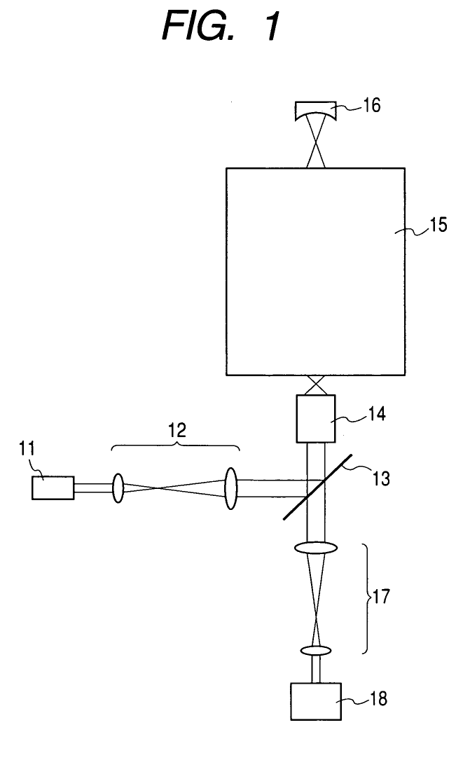

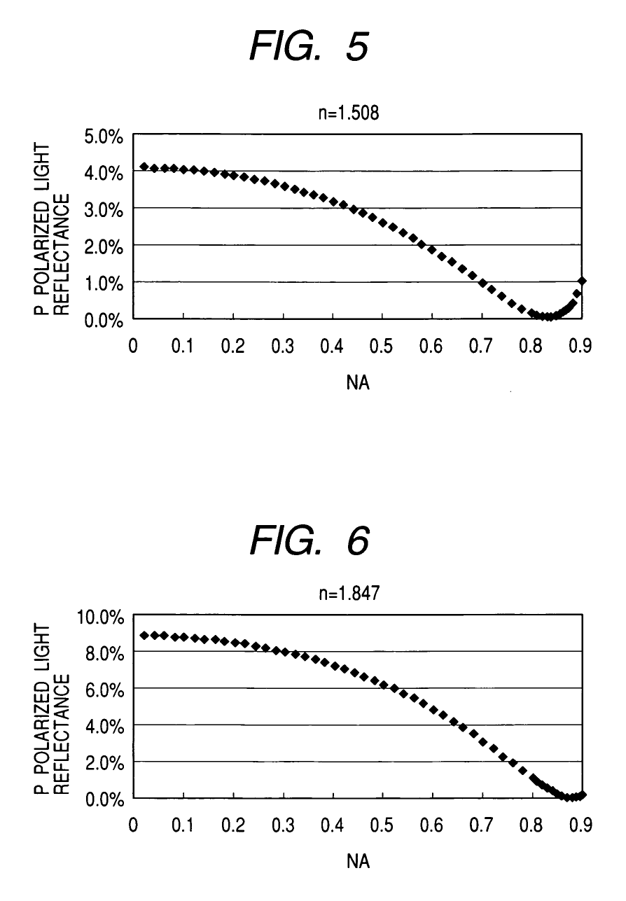

In the following, an embodiment of the present invention will be described with reference to the accompanying drawings. FIG. 1 shows an interferometer used for measuring a transmitted wavefront of a lens having a high numerical aperture (NA). In recent years, the NA of high NA lenses to be measured tends to exceed 0.8. In order to attain high accuracy in measurement, it is necessary for the Fizeau lens 14 that makes a wavefront of such an NA incident on the lens to be measured 15 to have an NA equal to or larger than that of the lens to be measured 15, that is, for example, an NA of 0.9. In addition, in the case that a transmitted wavefront of a lens to be measured that has a long optical path is to be measured by the Fizeau interferometer, a light source with a long coherence is necessary as the light source 11. However, the light source with a long coherence generally oscillates in linear polarization, and it suffers from the problem described above in connection with the cat's-eye measurement for measuring a system error when used as the light source of the aforementioned interferometer having a high NA. FIG. 5 is a graph showing the relationship between the NA and the reflectance for P polarized light in the case that a glass material having a refractive index of about 1.508 at the light source wavelength is used as a substrate for cat's-eye measurement. As will be seen from FIG. 5, the Brewster's angle at which the reflectance becomes zero is reached at an NA of about 0.83. When the NA is about 0.8, the reflectance becomes as low as 0.1%, and the contrast of interference fringes in the cat's-eye measurement is lowered, so that accuracy of wavefront measurement is considerably deteriorated or the measurement is even made impossible. In order to measure the interference fringes with high contrast, the reflectance is required to be at least 1% or more. In view of this, a glass material having a refractive index that satisfies the following formula (6) is used as a substrate for cat's-eye measurement.

$$n \geq \frac{NA}{\sqrt{1 - {NA}^{2}}} \qquad ( 6 )$$

In formula (6), NA represents the numerical aperture at which the Brewster's angle is reached. With use of a substrate for apex reflection having a refractive index that satisfies the condition of formula (6), it is possible to prevent the Brewster's angle from being reached below the numerical aperture of the interferometer.

Furthermore, in this embodiment, in order to attain a reflectance that allows wavefront measurement at a desired numerical aperture, the refractive index nₜₕ of the reflecting substrate is selected to satisfy the following formula (7).

$${n}_{th} \geq {( \frac{{( 1 + {r}_{0} )}^{2} + \sqrt{{( 1 + {r}_{0} )}^{4} - 4 {( 1 - {r}_{0}^{2} )}^{2} ( {NA}^{2} - {NA}^{4} )}}{2 {( 1 - {r}_{0} )}^{2} ( 1 - {NA}^{2} )} )}^{\frac{1}{2}} \qquad ( 7 )$$

r0: amplitude reflectance of P polarized light at the substrate.

NA: numerical aperture of incidence light flux.

For example, a sapphire substrate having a refractive index of about 1.847 at the light source wavelength of the interferometer is used as the reflecting substrate for the cat's-eye measurement. FIG. 6 is a graph showing the relationship between the NA and the reflectance for P polarized light in the case that a sapphire substrate having a refractive index of 1.847 is used. In this case, the NA that corresponds to the Brewster's angle at which the reflectance becomes zero can be made as high as 0.88 as will be seen from FIG. 6. In addition, the reflectance at NA=0.8 is 1.1%. Therefore, such sufficient contrast in the interference fringes that allows measurement can be achieved, and it is possible to carry out the cat's-eye measurement with high accuracy. Consequently, system error measurement of the interferometer can also be carried out with high accuracy, so that absolute accuracy of measurement of a wavefront transmitted through the lens to be measured will be enhanced. Although a sapphire glass having a refractive index of 1.847 is exemplarily used as an substrate used for apex reflection in this embodiment, the higher the refractive index is, the more effective the present invention will be.

An example of a lens to be measured having a high NA is a projection lens of a semiconductor exposure apparatus. The light source used for such a projection lens may be a KrF excimer laser having a wavelength of 248 nm or an ArF excimer laser having a wavelength of 193 nm etc. The above-described method can be applied to system error measurement of a high numerical aperture Fizeau interferometer that uses a light source using the above-mentioned wavelengths. For example, the sapphire glass has a refractive index of 1.847 at the wavelength of 248 nm, and therefore the system error of an interferometer having a numerical aperture of 0.8 or more can be measured with the sapphire glass.

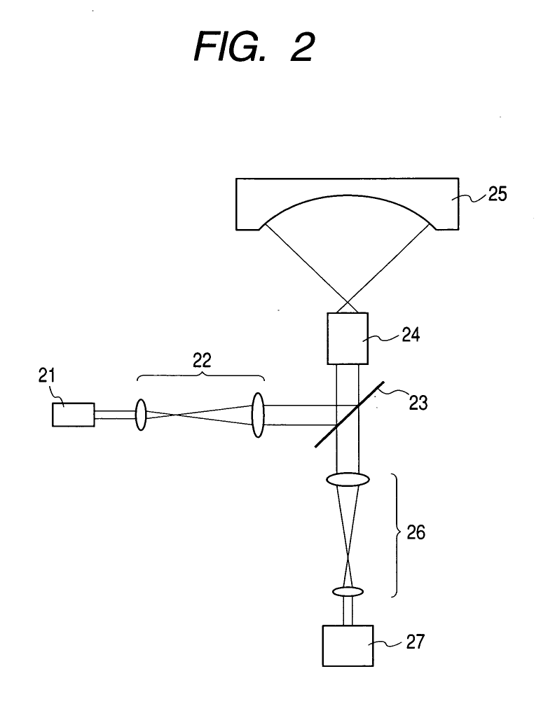

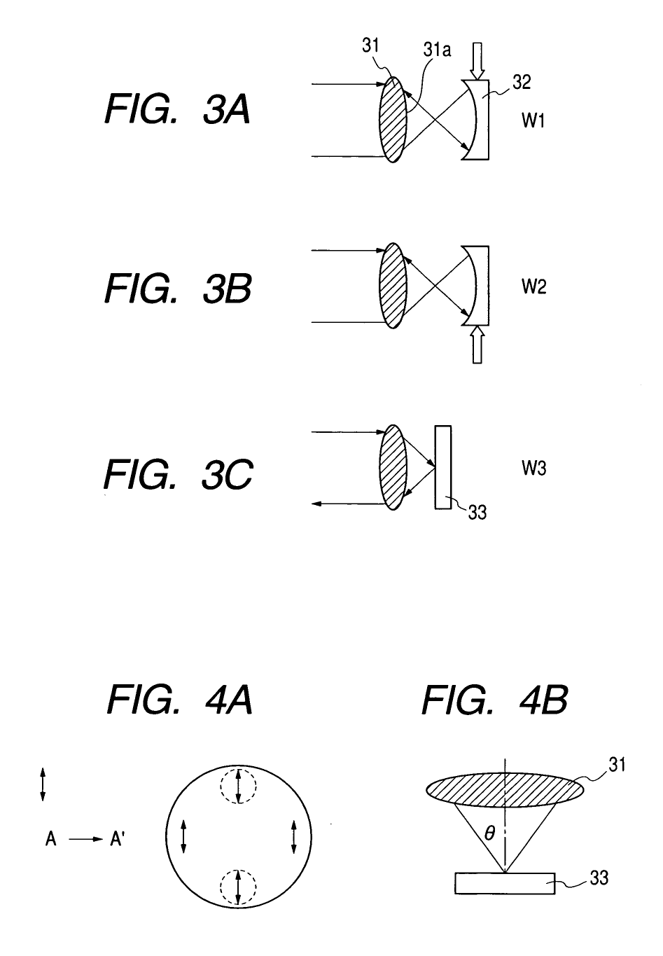

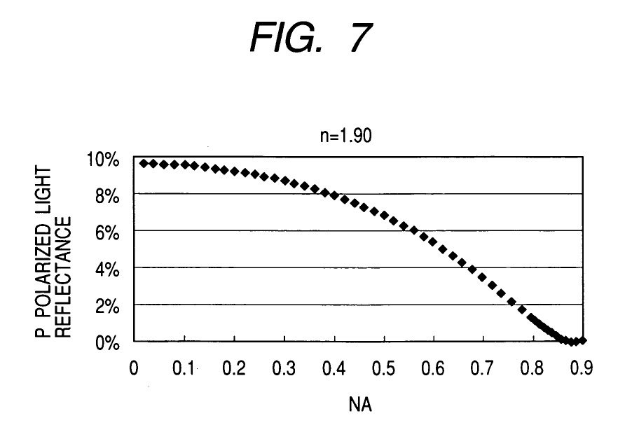

FIG. 2 shows a second embodiment of the present invention. FIG. 2 shows a Fizeau interferometer used for measuring a surface shape. The interferometer has a light source 21 in the form of a laser that oscillates a linearly polarized visible light. In the case that a surface 25 to be measured by this interferometer is a concave surface having a small R-number (which is defined as the radius of curvature of the surface divided by the diameter of the surface) e.g. an R-number of about 0.625 (corresponding to NA=0.8), the Fizeau lens 24 is required to have a numerical aperture of 0.8 or more. In order to ensure absolute accuracy in the surface shape in surface shape measurement also, it is essential to measure the system error of the interferometer with high accuracy. In view of this, highly precise system error measurement for NA=0.8 can be made possible by using as a substrate a glass material having a high refractive index that satisfies formula (7) at the light source wavelength of the interferometer. FIG. 7 is a graph showing a relationship between the NA and the reflectance for P polarized light in the case that glass material S-LAH58 (OHARA) having a refractive index of about 1.9 at the wavelength used by the interferometer. As will be seen from FIG. 7, the NA corresponding to the Brewster's angle at which the reflectance becomes zero can be made as large as 0.88, and the reflectance at NA=0.8 is 1.3%. Therefore, sufficient contrast in the interference fringes that allows measurement can be achieved, and it is possible to carry out the apex reflection measurement with high accuracy. Consequently, system error measurement of the interferometer can also be carried out with high accuracy, so that absolute accuracy in measurement of the surface shape of the lens to be measured will be enhanced.

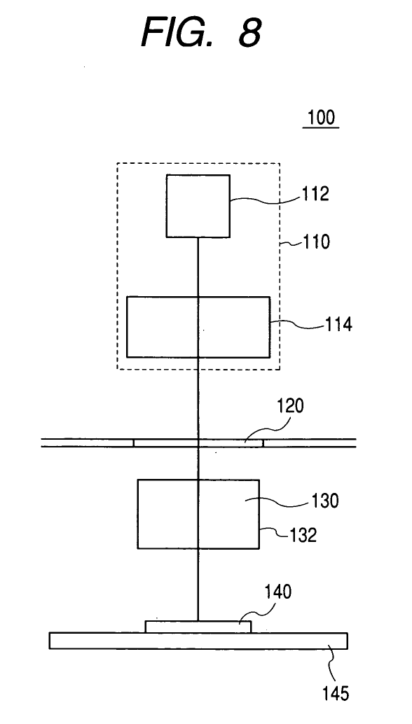

In the following, an exposure apparatus 100 equipped with a lens or a mirror included in a projection optical system that has been measured by the measurement apparatus according to the present invention will be described with reference to FIG. 8. FIG. 8 is a schematic block diagram of an exemplary exposure apparatus 100 according to the present invention. The exposure apparatus 100 has an illumination apparatus 110 for illuminating a mask 120 on which a circuit pattern is formed, a projection optical system 130 for projecting diffracted light generated at the illuminated mask pattern onto a plate 140 and a stage 145 for supporting the plate 140.

The exposure apparatus 100 is a projection exposure apparatus for exposing a circuit pattern formed on the mask 120 onto the plate 140 by a step and scan process or a step and repeat process. Such an exposure apparatus is suitable for the lithography process of a submicron order or quarter-micron order or less. The following description of this embodiment will be made with reference to a step and scan exposure apparatus (which is also referred to as a “scanner”) by way of example. Here, the “step and scan process” is a process in which a wafer is continuously scanned relative to a mask so that the mask pattern is exposed onto the wafer, and then the wafer is stepped so as to shift the exposure area to the next exposure area after completion of one exposure shot. On the other hand, the “step and repeat process” is a process in which a wafer is stepped so as to shift the exposure area to the next exposure area every time batch exposure is performed.

The illumination apparatus 110 includes a light source portion 112 and an illumination optical system 114 to illuminate the mask 120 on which the circuit pattern to be transferred is formed.

The light source portion 112 may be a light source of an ArF excimer laser with a wavelength of 193 nm, a KrF excimer laser with a wavelength of 248 nm or an F2 excimer laser etc. The type of the light source is not restricted to excimer lasers, but a YAG laser may also be used for example, and there is no limitation on the number of the light sources. In addition, an EUV light source may also be used. The light source used in the light source portion 112 is not limited to lasers, but one or more lamps such as a mercury lamp(s) or a xenon lamp(s) may also be used.

The illumination optical system 114 is an optical system for illuminating the mask 120 and it includes a lens(es), a mirror(s) a light integrator(s) and a stop(s). For example, the illumination optical system includes a condenser lens, a fly-eye lens, an aperture stop, a condenser lens, a slit and an imaging optical system arranged in the mentioned order. The illumination optical system 114 can be used irrespective of on-axis rays or off-axis rays. The light integrator includes an integrator that is formed by assembling a fly-eye lens and two sets of cylindrical lens array (or a lenticular lens) plates. This may be replaced by an optical rod or a diffraction element.

The mask 120 is made of for example quartz and a circuit pattern (or an image) to be transferred is formed on it. The mask 120 is supported and drinven by a mask stage that is not shown in the drawings. The diffracted light generated at the mask 120 is projected onto the plate 140 via the projection optical system 130. The mask 120 and the plate 140 are in an optically conjugate relationship with each other. The exposure apparatus 100 of this embodiment is a scanner, and the pattern on the mask 120 is transferred onto the plate 140 while the mask 120 and the plate 140 are scanned at a speed ratio equal to the reduction ratio. On the other hand, in the case of a step and repeat exposure apparatus (which is also called a stepper), the exposure is performed while the mask 120 and the plate 240 are in a stationary state.

The projection optical system 130 may be an optical system consisting of a plurality of lens elements, an optical system including a plurality of lens elements and at least one concave mirror (i.e. a catadioptric optical system), an optical system including a plurality of lens elements and at least one diffraction optical element such as a kinoform or an all-mirror type optical system. In the case that correction of color aberration is necessary, a plurality of lens elements made of glass materials having dispersion values (or Abbe's numbers) different from each other may be used, or a diffraction optical element may be arranged in such a way as to generate a dispersion in the direction opposite to that of the lens elements. An element that has been measured by the interferometer shown in FIG. 1 or FIG. 2 may be used as a projection lens or mirror in the projection optical system 130. With the use of such a lens or a mirror, the projection optical system 130 can have a high NA and small aberrations, so that desired optical performance can be achieved.

The plate 140 is an object to be processed such as a wafer or a liquid crystal substrate on which a photoresist is applied. The photoresist application process includes a preliminary treatment, application of an adhesion promoting agent, application of a photoresist and pre-baking. The preliminary treatment includes cleaning and drying etc. The application of an adhesion promoting agent is a process for modifying surface properties for improving adhesion of the photoresist and the underlying member (that is, making the surface hydrophobic by applying a surface active agent). Specifically, an organic film such as hexamethyl-disilazane (HMDS) is applied by coating or vapor processing. The pre-baking is a baking process for removing solvent, which is softer than the baking performed after development.

The stage 145 supports the plate 140. The stage 145 may be of any form that is known in the art, and the detailed description of its structure and operation will be omitted. For example, the stage 145 may be adapted to move the plate 140 in the X and Y directions by means of linear motors. The mask 120 and the plate 140 are for example scanned synchronously, while the position of the stage 145 and the mask stage (not shown) is monitored by for example laser interferometers, so that the mask 120 and the plate 140 are moved at a constant speed ratio. The stage 145 is mounted on a stage platen that is supported on the floor or the like via a damper. The mask stage and the projection optical system are mounted on a lens barrel platen (not shown) that is supported on a base frame placed on the floor or the like via a damper.

Upon exposure, a light flux emitted from the light source 112 is caused to illuminate the mask 120 (for example as Koehler illumination) by means of the illumination optical system 114. The light that has passed through the mask 120 and reflects on the mask pattern is imaged by the projection optical system onto the plate 140. Since the projection optical system 130 used in the exposure apparatus 100 can suppress aberrations, it is possible to provide devices (such as semiconductor devices, LCD elements, image pickup elements (such as CCDs) and thin film magnetic heads) having a quality better than conventional devices at a high throughput rate, with high economic efficiency.

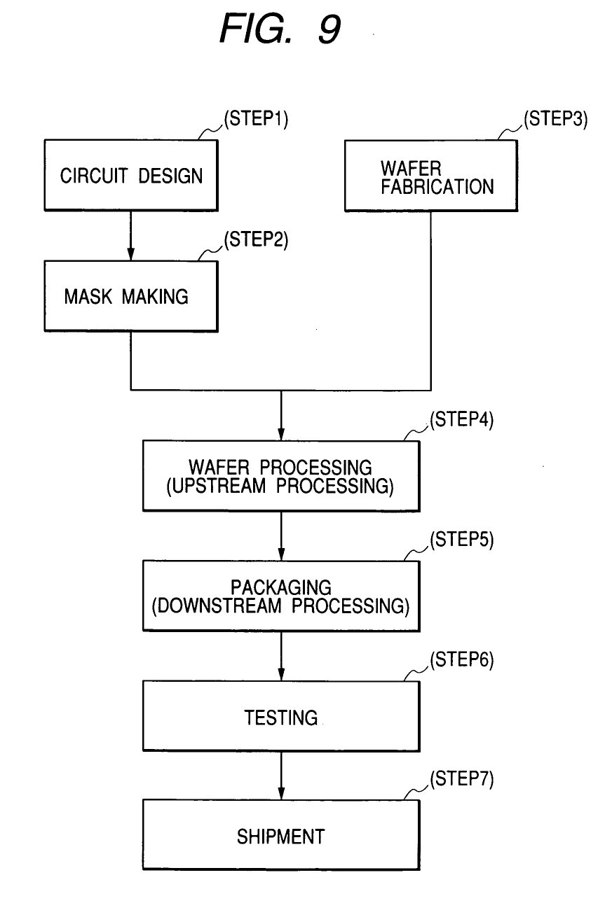

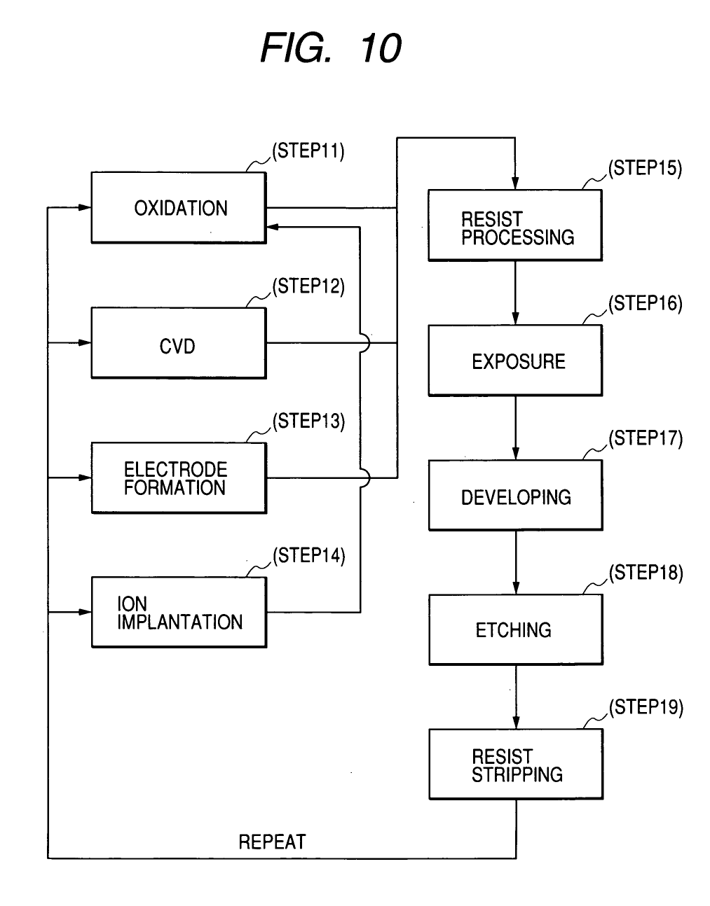

In the following, an embodiment of a device manufacturing process utilizing the above-described exposure apparatus will be described with reference to FIGS. 9 and 10. FIG. 9 is a flow chart for illustrating a manufacturing process of devices (e.g., semiconductor chips such as ICs or LSIs, LCDs or CCDs etc.). Here, a manufacturing process of semiconductor chips will be described by way of example. In step 1 (circuit design), the circuit of the device is designed. In step 2 (mask making), a mask on which a pattern of the designed circuit is formed is produced. In step 3 (wafer fabrication), a wafer is produced using silicon or like materials. In step 4 (wafer process), which is called an upstream processing, circuits are actually formed on the wafer by a lithography technology using the mask and the wafer. Step 5 (packaging) is called a downstream processing in which semiconductor chips are produced from the wafer processed in step 4. Step 5 includes an assembling process (i.e. dicing and bonding) and a packaging process (i.e. chip packaging) etc. In step 6 (testing), inspections such as an operation test and durability test etc. of the semiconductor devices produced in step 5 are performed. Then, the finished semiconductor devices produced by the above-described processes are shipped (step 7).

FIG. 10 is the detailed flow chart of the wafer process of step 4 shown in FIG. 9. In step 11 (oxidation), the surface of the wafer is oxidized. In step 12 (CVD), an insulating film is formed on the surface of the wafer. In step 13 (electrode formation), electrodes are formed on the wafer by vapor deposition or the like process. In step 14 (ion implantation), ions are implanted into the wafer. In step 15 (resist processing), a photosensitive material is applied on the wafer. In step 16 (exposure), a circuit pattern on the mask is exposed (or transferred) onto the wafer using the exposure apparatus 100. In step 17 (developing), the wafer that has been exposed is developed. In step 18 (etching), the portions other than the developed resist image are etched away. In step 19 (resist stripping), the useless resist after the etching is removed. The above-described steps are repeated multiple times, so that multi-layered circuit patterns are formed on the wafer. With the device manufacturing process according to this embodiment, it is possible to manufacture devices having an improved quality as compared to conventional devices using a projection lens with reduced aberrations. As per the above, the device manufacturing method using the exposure apparatus and resultant products in the form of the devices are also included in the scope of the present invention.

While preferred embodiments of the present invention have been described in the forgoing, it is apparent that the present invention is not limited to those embodiments, but various modification or changes can be made on them within the scope of the present invention. For example, although a Fizeau interferometers has been described in the first and second embodiments, the Fizeau interferometer may be replaced by a Twyman-Green interferometer.

As per the above, with the above-described embodiments of the present invention, it is possible to measure a system error of an interferometer having a numerical aperture larger than conventional interferometers with high accuracy. It is also possible to improve absolute accuracy in measuring a transmitted wavefront of a lens with a high numerical aperture or a surface shape with a small R-number.

What is claimed is:

1. A method for measuring aberration of an optical system that constitutes an interferometer, comprising the steps of:
disposing a reflecting member at an image point of said optical system; and
detecting, by detection means, interference fringes formed based on light that has been emitted from a light source, transmitted through said optical system, caused to illuminate said reflecting member, reflected by said reflecting member and transmitted through said optical system again;
wherein a refractive index of said reflecting member with respect to said light is equal to or larger than 1.8.

2. A method according to claim 1, wherein a numerical aperture on said reflecting member side of an optical system that constitute said interferometer is equal to or larger than 0.8.

3. A method according to claim 1, wherein said reflecting member is made of sapphire.

4. A method according to claim 1, wherein said interferometer is a Fizeau interferometer.

5. A method according to claim 1, wherein said light is linearly polarized light.

6. An exposure apparatus comprising:
a projection optical system for projecting an original pattern onto a substrate, wavefront aberration of said projection optical system having been measured by an interferometer and aberration of an optical system that constitutes said interferometer having been measure by a method comprising the steps of:
disposing a reflecting member at an image point of said optical system; and
detecting, by detection means, interference fringes formed based on light that has been emitted from a light source, transmitted through said optical system, caused to illuminate said reflecting member, reflected by said reflecting member and transmitted through said optical system again;
wherein a refractive index of said reflecting member with respect to said light is equal to or larger than 1.8.
